(19) United States
(12) Patent Application Publication
(10) Pub. No.: US 2022/0202023 A1
(43) Pub. Date: Jun. 30, 2022

(54) Slicing Apparatus

(71) Applicant: Edge Exponential LLC, Gahanna, OH (US)

(72) Inventors: Hayden Frea, Gahanna, OH (US); James E. Grote, Gahanna, OH (US); Jeremy Y. Mak, Hilliard, OH (US)

(21) Appl. No.: 17/566,890

(22) Filed: Dec. 31, 2021

Related U.S. Application Data
(60) Provisional application No. 63/132,857, filed on Dec. 31, 2020.

(51) Int. Cl. A21C 9/04; B26D 3/24; A21D 13/41

(52) U.S. Cl. CPC A21C 9/04; A21D 13/41; B26D 3/24

(57) ABSTRACT

An apparatus for cutting slices from a food product includes a vertical housing defining a barrel that receives an elongated food product. A rotatable blade apparatus is disposed beneath the lower end of the housing and has a planar guide with a slot. A first blade is mounted to the top surface of the guide with a sharp blade edge adjacent the slot and facing radially outwardly. Drive means rotates the rotatable blade apparatus into the food product to form slices. A substrate is disposed beneath the rotatable blade apparatus for receiving slices formed by the rotatable blade apparatus. The substrate may be a pizza crust and the food product may be a pepperoni stick.

### BACKGROUND OF THE INVENTION

The invention relates broadly to food processing equipment and more specifically to an apparatus for slicing elongated food products, such as a pepperoni stick.

It is well known that elongated food products, such as logs or sticks of food, including pepperoni, salami, and other sausages, may be cut from an elongated shape into slices. Sausages are typically formed by stuffing a casing with ground food ingredients, and pepperoni is an example. Other elongated food products, such as cheese and cucumbers may also be sliced prior to consumption.

When slicing sausage, in particular, it is commonly desirable to form slices of equal thickness so that a predictable amount of the food product is placed on a substrate, such as a pizza crust or a slice of bread. It is also desirable, when feasible, to slice the food as close to the time it is consumed in order to preserve its freshness in taste and appearance.

Sausage is particularly difficult to slice cleanly because the casing can differ significantly in toughness and density compared to the ground food within the casing. When an elongated food product is not cleanly sliced, it is possible for a so-called “tail” to be formed on or near each poorly cut slice. A tail is a portion of the log that is from the same plane as the previously-formed slice, but it remains attached to the log. One difficulty with pepperoni sticks, as an example, is that the casing (skin) is notoriously difficult to cut without leaving a tail behind. If a tail is left behind, that will continue to build up with each slice and then each slice has an unpredictable mass. This causes inconsistencies in each slice's appearance, too.

After slicing pepperoni that will be placed on a pizza, the slices must be placed on the crust in an organized manner. Often pepperoni is applied by hand, but this requires substantial experience and skill to apply in an efficient manner. Conventional slicing mechanisms cut at 600-1,000 revolutions per minute. This rapid motion can cause the pepperoni slices to project outwardly from the cutting mechanism, which makes placement of any given slice directly from a slicing machine difficult or impossible.

### SUMMARY OF THE INVENTION

Disclosed herein is an apparatus for slicing a pepperoni stick and other food logs into slices, and that apparatus places the slices predictably beneath the slicer. The slicer desirably drops the slices onto an awaiting surface, which may be a stationary or a rotating pizza crust. An advantage of the apparatus is that it cuts the pepperoni and applies it directly to the crust, which avoids a second step of hand-application. Furthermore, slicing and then immediately applying the slices to the substrate keeps the pepperoni fresh by enabling a process of slicing immediately before the pepperoni is applied to the crust.

The rotating blade of the apparatus begins to slice on one side of the pepperoni log and continues through the log as the blade rotates. By the time the pepperoni log is almost completely sliced through using the rotating blade with an outwardly-facing blade, a second, inwardly-facing blade cuts from the outside to separate the pepperoni slice from the log. By cutting this way, using two blades, the cutting avoids forming a “tail” on the food product, and each slice is consistently the same thickness and weight. The second, inwardly-facing blade is optional.

After being sliced the pepperoni falls downwardly through a slot in a guide upon which the food product rests during slicing. The slot is between the guide and the first blade, which first blade has a radially-outwardly facing sharp edge. The pepperoni rests on the guide and the thickness of the slice is determined by the position of the first blade relative to the guide.

Disclosed herein is an apparatus for cutting slices from a food product. The apparatus comprises a housing defining a barrel configured for receiving an elongated food product. The apparatus comprises a rotatable blade apparatus disposed adjacent the housing for cutting slices from the elongated food product during rotation. The rotatable blade apparatus has a substantially planar guide with a slot formed therethrough and a top surface disposed a first predetermined distance from the housing. The rotatable blade apparatus also has a first blade mounted to the guide and arranged with a sharp edge adjacent the slot, facing radially outwardly and disposed a second, predetermined distance from the housing. The apparatus also comprises a substrate disposed adjacent the rotatable blade apparatus for receiving slices formed by the rotatable blade apparatus.

In some embodiments a second blade is mounted to the guide adjacent the first blade and a sharp edge of the second blade faces the sharp edge of the first blade. In some embodiments the substrate is rotatable about a substrate axis. In some embodiments the substrate is laterally moveable relative to the substrate axis. Some embodiments further comprise a displaceable cart disposed, in an operable orientation, beneath the rotatable blade. The cart may have a rotatable tray with an upper surface defining the substrate. Some embodiments further comprise a prime mover drivingly linked to the cart for displacing the cart laterally relative to an axis of rotation of the rotatable blade apparatus. In some embodiments the substrate is moveable along the rotational axis to position the substrate closer to the housing during slicing. In some embodiments, in an operable orientation, the housing is substantially vertical, the rotatable blade apparatus is disposed beneath the housing near an end of the barrel and the substrate is disposed beneath the rotatable blade apparatus. In some embodiments, the first predetermined distance differs from the second predetermined distance by an amount substantially equal to a thickness of at least one of the slices.

Disclosed herein is an apparatus for cutting slices from a food product. The apparatus comprises a housing, which in an operable orientation is substantially vertical, defining a barrel configured for receiving an elongated food product. The apparatus further comprises a rotatable blade apparatus disposed, in an operable orientation, beneath the housing near an end of the barrel, for cutting slices from the elongated food product. The rotatable blade apparatus has a substantially planar guide with a slot formed therethrough and a top surface disposed a first predetermined distance from the housing. The rotatable blade apparatus also has a first blade mounted to the guide and arranged with a sharp edge adjacent the slot, facing radially outwardly and disposed a second, predetermined distance from the housing. The first predetermined distance and the second predetermined distance differ by a thickness of at least one of the slices. The apparatus further comprises a substrate disposed, in an operable orientation, beneath the rotatable blade apparatus for receiving the slices formed.

In some embodiments the rotatable blade apparatus further comprises a second blade mounted to the guide adjacent the first blade and a sharp edge of the second blade faces the sharp edge of the first blade. In some embodiments, the substrate is rotatable about a substrate axis. In some embodiments, the substrate is moveable along the substrate axis to position the substrate closer to the housing during slicing. In some embodiments, the substrate is moveable laterally relative to the substrate axis.

Disclosed herein is a method of forming a pizza. The method comprises disposing an elongated food product in a barrel formed in a housing, which in an operable orientation is substantially vertical. The method also comprises disposing a rotatable blade apparatus beneath the housing near an end of the barrel. The rotatable blade apparatus has a substantially planar guide with a slot formed therethrough and a top surface disposed a first predetermined distance from the housing. The rotatable blade apparatus also has a first blade mounted to the guide and arranged with a sharp edge adjacent the slot, facing radially outwardly and disposed a second, predetermined distance from the housing. The method further comprises rotating the rotatable blade apparatus with an end of the elongated food product resting on the top surface of the guide and the first blade's sharp edge in contact with the elongated food product. This thereby cuts slices from the elongated food product that extend through the slot and fall beneath the guide. The method further comprises disposing a substrate below the guide for receiving slices.

In some embodiments, the substrate is a pizza crust and the elongated food product is a pepperoni stick or log. In some embodiments, the step of disposing the substrate further comprises rotating the substrate about a substrate axis and simultaneously displacing the substrate laterally of the substrate axis.

### BRIEF DESCRIPTION OF THE DRAWINGS

FIG. 1 is a view in perspective illustrating an embodiment of the present invention.

FIG. 2 is a side view illustrating the embodiment of FIG. 1.

FIG. 3 is an exploded view in perspective illustrating a blade apparatus.

FIG. 4 is a top schematic view illustrating the blade apparatus.

FIG. 5 is a top view illustrating a first blade.

FIG. 6 is a side view illustrating the blade of FIG. 5.

FIG. 7 is a view in perspective illustrating the blade of FIG. 5.

FIG. 8 is a top view illustrating a second blade.

FIG. 9 is a side view illustrating the blade of FIG. 8.

FIG. 10 is a view in perspective illustrating the blade of FIG. 8.

FIG. 11 is a side view illustrating an embodiment of the invention in a first position.

FIG. 12 is a side view illustrating the embodiment of FIG. 11 in a second position.

FIG. 13 is a bottom view illustrating an embodiment of the guide.

FIG. 14 is a side view in section illustrating the guide of FIG. 13 through the lines 14-14.

FIG. 15 is a view in perspective illustrating an embodiment of the assembled blade apparatus 30.

FIG. 16 is a view in perspective illustrating the lower portion of the frame and one embodiment of a mechanism for driving the cart.

FIG. 17 is a top schematic view illustrating an alternative embodiment of the blade apparatus.

FIG. 18 is a view in perspective illustrating an alternative embodiment slicer.

FIG. 19 is a view in perspective illustrating the alternative embodiment of FIG. 18.

FIG. 20 is an exploded view in perspective illustrating an alternative embodiment of a blade apparatus.

FIG. 21 is view in perspective illustrating the embodiment of FIG. 20.

FIG. 22 is a top view illustrating an alternative embodiment of a first blade.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

Patent application Ser. No. 63/132,857 filed Dec. 31, 2020, which is the above claimed priority application, is incorporated in this application by reference.

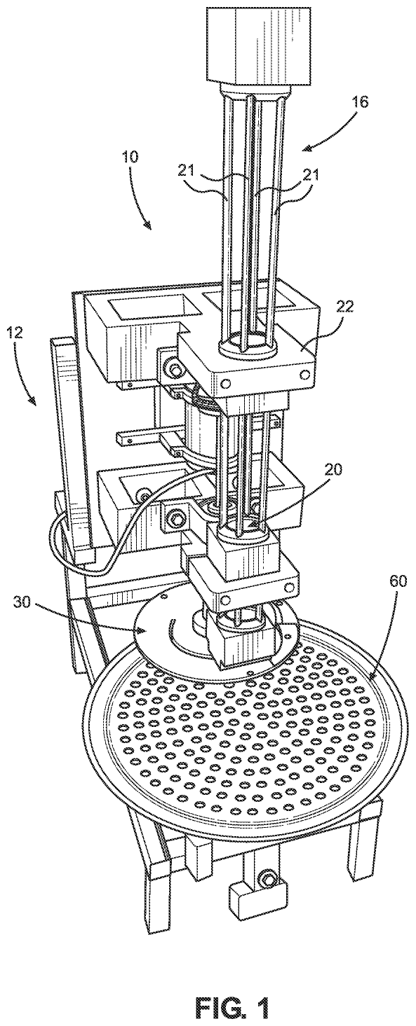

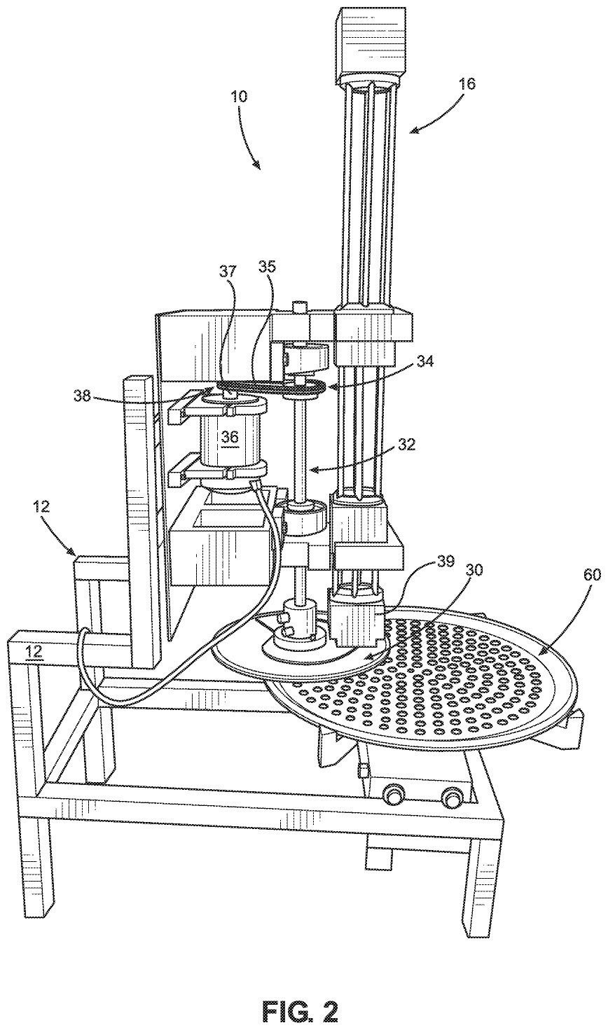

A food slicer 10 is shown in FIGS. 1 and 2 and includes a frame 12 that may rest upon a table, a countertop, a floor, the ground or any suitable surface. The frame 12 is a rigid structure, which may be made of steel or another rigid material, to which other components of the food slicer 10 are mounted and held in position relative to one another. A food-holding tower 16 mounts to the frame 12, and an elongated food product may be placed in the tower 16 in a generally vertical orientation in the configuration shown in FIG. 1. The tower 16 may be immobile relative to the frame 12 and may have an open structure, such as by disposing parallel metal rods 21 around a cylindrical void, referred to herein as a barrel 20. The barrel 20 may alternatively be formed inside a metal or plastic cylindrical housing, tube or any suitable structure defining a barrel-shaped void that accommodates the shape of the food product. The barrel 20 is at least as large as the food product, such as a log of pepperoni (not shown), that is desirably placed in the barrel 20. The barrel 20 extends vertically in an operable position as described in more detail herein.

A blade apparatus 30 is rotatably mounted to the frame 12 and disposed at the lower end of the barrel 20 in the operable orientation shown in FIGS. 1-2. The blade apparatus 30 receives the lower end of any food product that is placed in the barrel 20, and defines one extreme end of the barrel 20. The blade apparatus 30 is preferably rotatably mounted to the frame about an axis that is substantially vertically oriented, which axis may be the driveshaft 32 that is rotatably mounted to the frame 12. A prime mover, which may be the electric motor 36 mounted to the frame 12, has a sprocket 38 mounted to its driveshaft 37. A chain 35 drivingly links the sprocket 38 to the sprocket 34 that is mounted to the driveshaft 32 on which the blade apparatus 30 is mounted. Upon rotation of the driveshaft 37 of the motor 36, the sprocket 38 is driven in rotation, which displaces the chain 35 and thereby rotates the sprocket 34 on the driveshaft 32, which thereby rotates the blade apparatus 30. The rotational speed of the driveshaft 32 during operation may be, as an example, 60-100 revolutions per minute (rpm), and this may be varied by modifying the sizes of the sprockets 34 and 38, or the rotational speed of the motor 36.

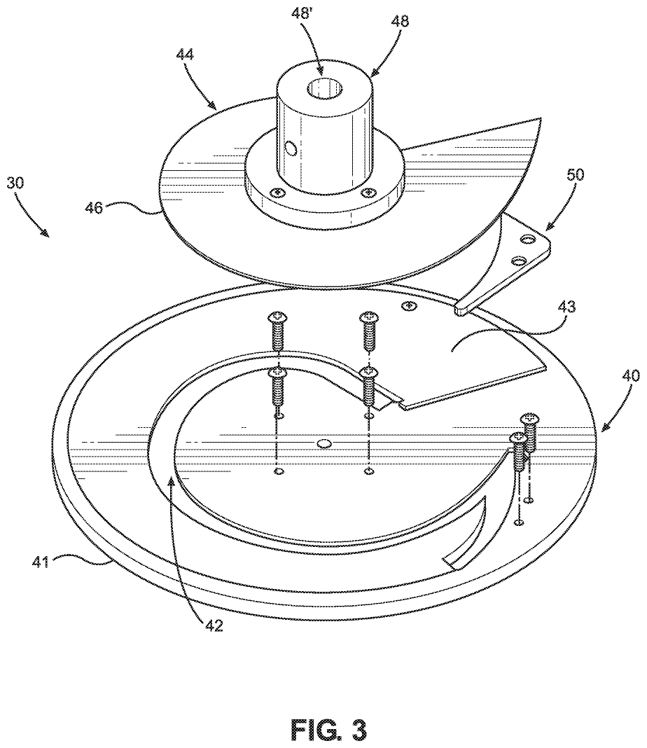

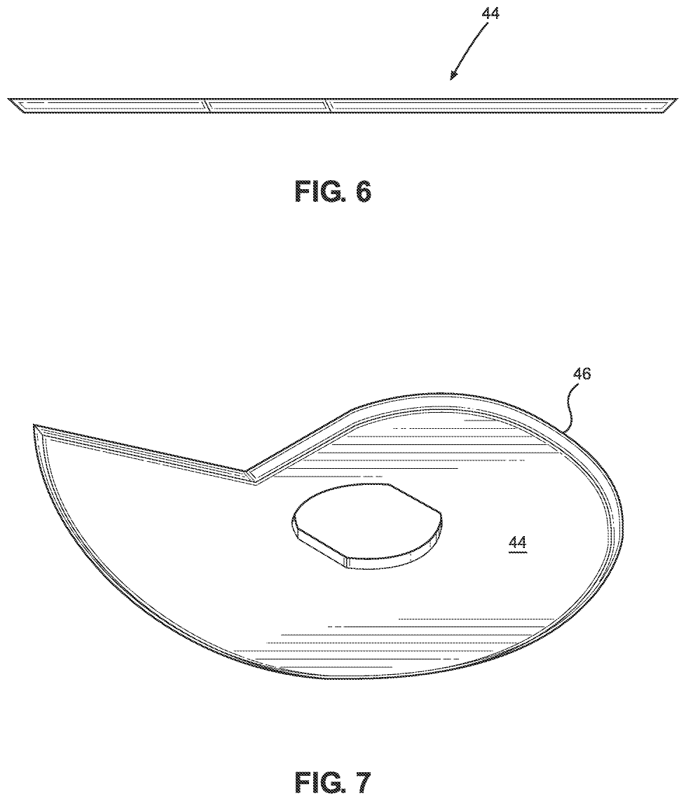

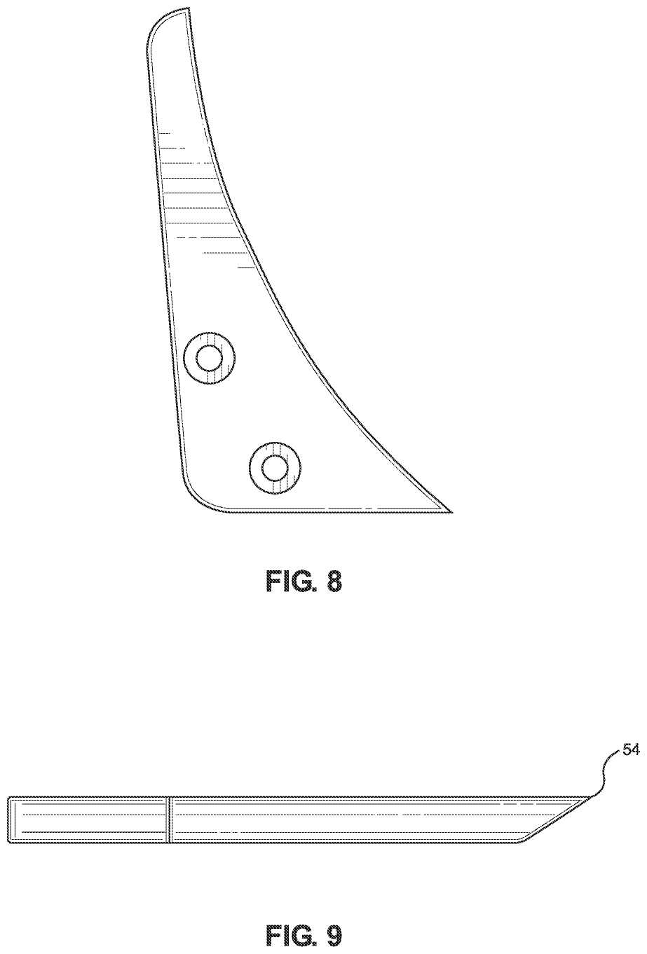

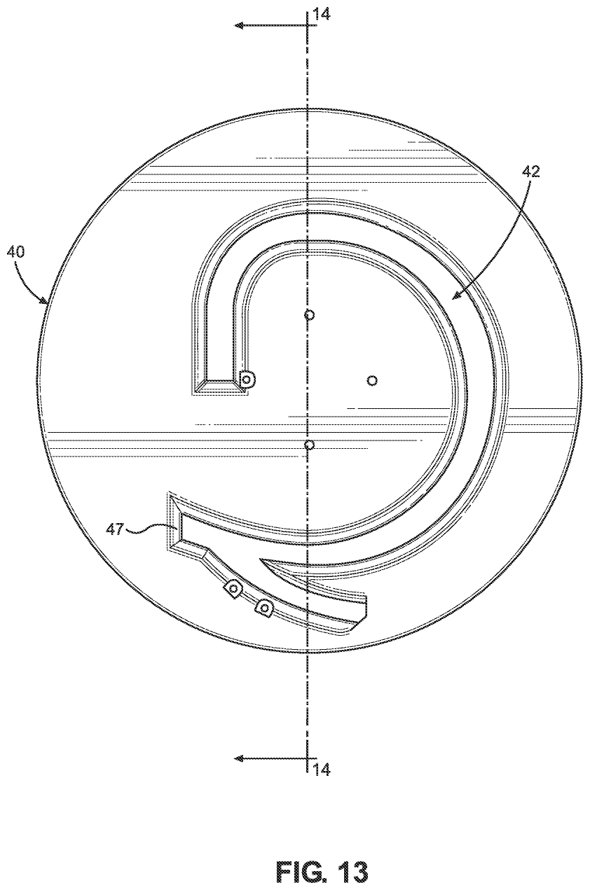

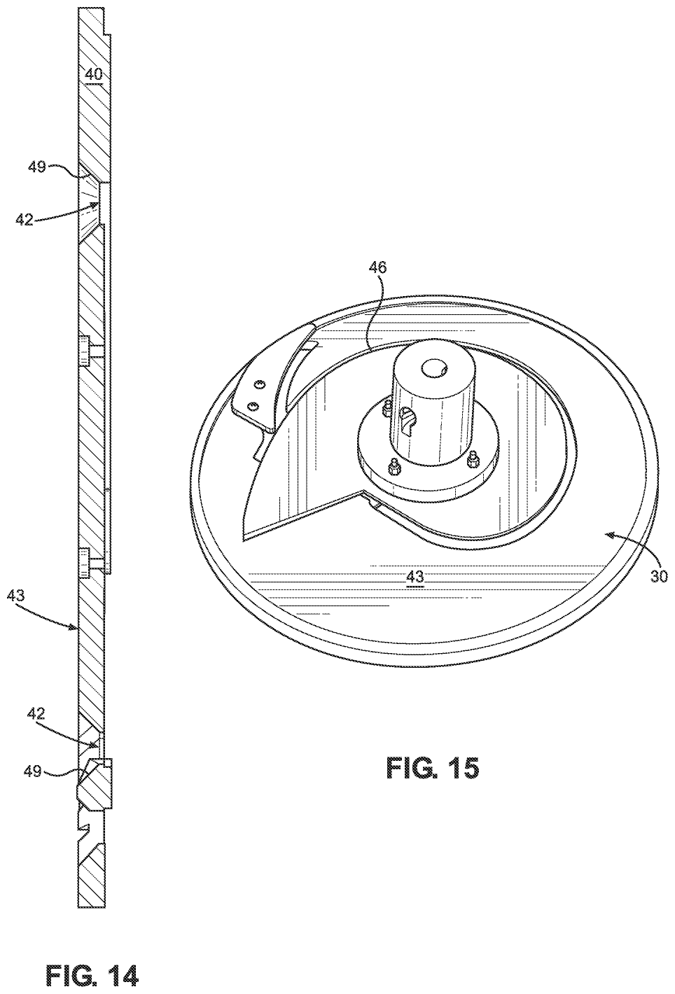

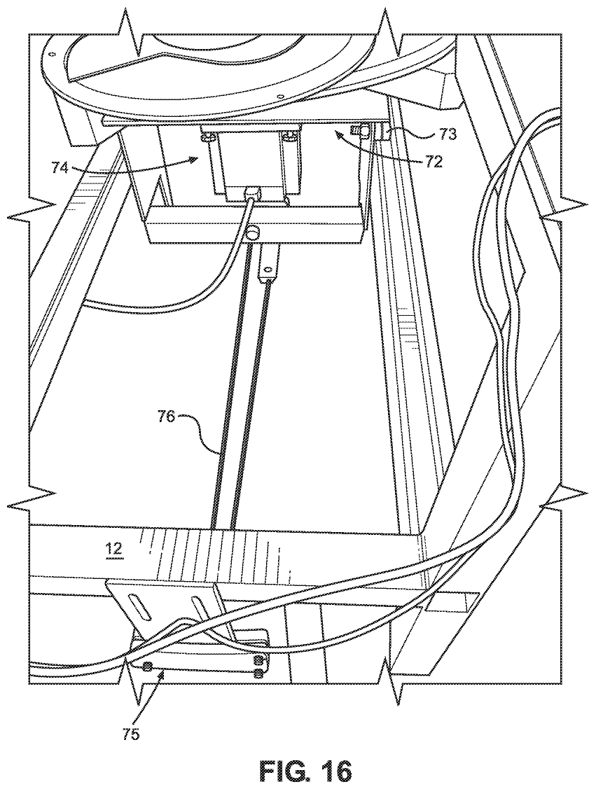

The blade apparatus 30 may include a guide 40 and first and second blades 44 and 50, respectively, as shown in FIGS. 3-10 and 13-15. The guide 40 may be a substantially planar, polymer disk with a substantially circular peripheral edge 41 and a slot 42 formed through the guide 40 radially within the peripheral edge. One or more of the edges that define the slot 42 may be sharpened sufficiently to slice food product used in the slicer 10 or may be blunt and incapable of substantial cutting of food product. As shown in FIG. 14, the side or sides of the slot 42 are chamfered to permit food slices to pass therethrough, and are not sharpened sufficiently to slice food product that the blade 44 is designed to slice. The guide 40 may be made of metal or any suitable material.

The first blade 44, which may be planar, may be removably mounted to the guide 40, such as by screws, and may have attached, or integral, to it a sharpened peripheral edge 46 that is an involute or a nearly-involute shape. The sharpened edge 46 is preferably able cleanly to slice through food products that have been described herein, and in particular pepperoni sticks. The blade 44 may be made of tool steel or any other suitable material. The blade 44 may have a driveshaft-receiving member 48 with an elongated opening 48′ extending perpendicularly to the plane of the blade 44. The opening 48′ drivingly receives the driveshaft 32 so that, upon rotation of the driveshaft 32, the entire blade apparatus 30, including the member 48, the guide 40 and the attached blade 44, are rotated about the axis of the driveshaft 32.

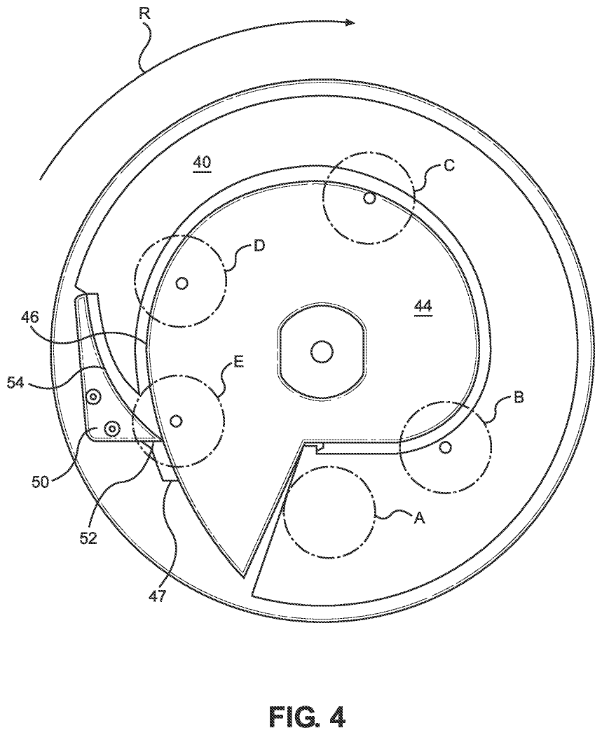

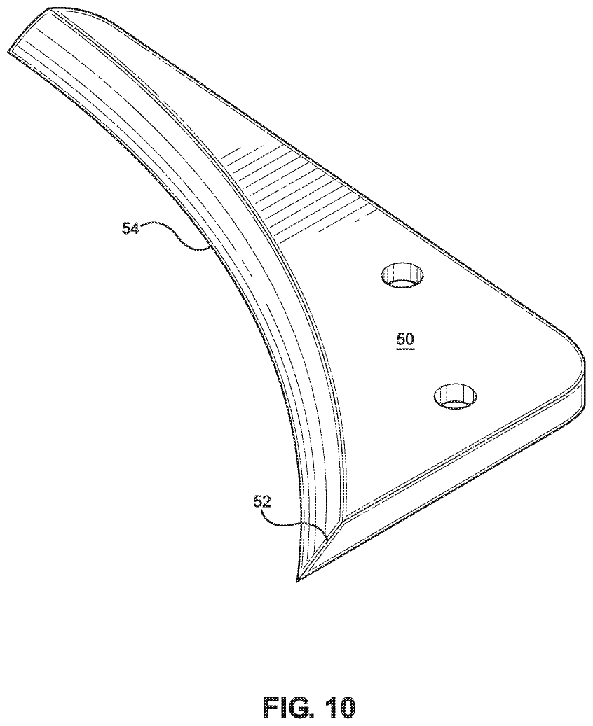

A second blade 50, which is optional, may be disposed adjacent the first blade 44, such as by mounting to the guide 40, using fasteners, such as screws near one end of the slot 42. The radially inwardly facing edge of the tip 52 (see FIG. 10), and optionally the entire inwardly-facing edge 54 of the blade 50, may be sharpened and able cleanly to slice through food products that have been described herein, and in particular pepperoni sticks. The sharpened edge 54 is preferably aligned with the sharpened edge 46 of the blade 40 as shown in FIG. 4 so that the sharp edges 46 and 54 of the blades 40 and 50, respectively, are in substantially the same plane. The tip 52 of the second blade 50 is positioned radially very close to the sharpened edge 46 of the first blade 44. The radial distance may be 1.0 mm or less, or it may be about a few millimeters.

During operation of the slicer 10, the bottom end of the food log rests upon the top surface 43 of the guide 40. The top surface 43 of the guide 40 is spaced vertically below (a distance measured along a line perpendicular to the plane of the first blade 44) the sharp edge 46 of the first blade 44 an amount substantially equal to the desired thickness of a slice the blade apparatus 30 forms during operation. Because the lower surface of the food log is positioned by the top surface 43 of the guide 40, and the top surface of any slice is formed by the sharp edge 46 of the first blade 44, the thickness of any slice is determined by the height of the sharp edge 46 relative to the top surface 43.

The width of the slot 42 through the guide 40 is large enough to permit slices to fall through but not so large that there is too small of a top surface 43 for the food log in the barrel 20 to rest upon. Thus, the slot 42 is at least as wide as the thickness of the slices the blade apparatus 30 forms during operation, and this permits the slices to pass through the slot 42 as described herein. The size of the slot 42 is preferably greater than the thickness of the pepperoni slice, so that there is enough room for slices to pass through the slot 42 with some provision for variation. As an example, a slice of pepperoni may be about 1/32 inch thick and the width of the slot 42 may be about one-quarter inch.

One or more edges 49 that define the slot 42 may be chamfered sufficiently to encourage slices to pass therethrough, but may not be sharpened to cleanly cut food product. Without a chamfered edge or edges 49, the pepperoni slices may not fold down from the log and pass through the slot 42. The sharpened edge 46 and the inwardly facing edge 49 defining the slot 42 preferably have the same curvature, but are spaced radially.

One cycle of slicing of a pepperoni stick will now be described, but it should be understood that, during operation, the blade apparatus 30 preferably rotates continuously, and each such slicing cycle is repeated in rapid succession. Nevertheless, one such cycle is described as follows for illustrative purposes. Additionally, a pepperoni stick is described at various locations on the blade apparatus 30, and in FIG. 4 the locations of the stick appear to move while the blade apparatus 30 appears to remain stationary. In a preferred embodiment, the blade apparatus 30 moves and the pepperoni stick remains radially stationary; the illustration is understood to include relative movement of the stick and the guide 40.

The lower end of a pepperoni log or stick (shown as a circle to represent a cross section of the roughly circular cylindrical pepperoni stick) rests on the top surface 43 of the guide 40 at the location designated A in FIG. 4. The blade apparatus 30 is rotated in the direction of the arrow, R by the motor 36 driving the drive shafts, sprockets and chain described herein. As the blade apparatus 30 rotates, the outwardly-facing blade edge 46 begins to apply a radially-outwardly facing force on the outer casing of the pepperoni at a location spaced vertically from the guide's top surface 43, a distance equal to the thickness of the slice eventually formed. The force applied to the food log by the blade edge 46 does not radially displace the pepperoni stick substantially because the rods 21, and the guide 39 mounted at the lower ends of the rods 21, restrain the food log radially, and so the blade edge 46 simply begins to slice into the food log. The food log is first sliced by the blade 44 in a radially-outward direction after the log is at position A and is moved toward position B. As the slice is formed, the radially-inwardly facing edge inserts into the slot 42 (where there is overlap between the slice and the blade 44) and begins to hang, by force of gravity and by guiding of the chamfered edge 49, beneath the blade 44. As the blade rotates to position B and then beyond, the edge 46 inserts further in a radially-outward direction into the log and cuts the slice further as shown when the pepperoni is at position C in FIG. 4. Continued rotation of the blade apparatus 30 causes further slicing and further movement of the slice through the slot 42 as the food log is at position D and moves toward position E.

As the stick passes position D and approaches the second blade 50, the first blade 44 may cease cutting further into the food log, or the blade 44 may continue to cut until the food log reaches the blade 50. Regardless of which alternative, the blade 50 eventually contacts the food log's radially-outwardly facing surface (the casing) and the edge 54 cuts radially-inwardly from the outside toward the already formed slice that is hanging through the slot 42. Thus, as the blade apparatus 30 is rotated further relative to the food log, the blade 50 further slices the food log, preferably along the same plane as the first blade 44 sliced, but progressing in the opposite direction.

The sharp edge 54 of the second blade 50 is preferably aligned vertically (along a line perpendicular to the plane of the blade 44), and preferably in the same plane, with the sharp edge 46 of the first blade 44, thereby meeting the cutting path of the slice formed by the first blade 44 and completely separating the slice from the food log. The blade apparatus 30 then begins a new cutting cycle by rotating until the pepperoni stick is in location A again and the cycle repeats as described above.

Once each slice is fully separated from the stick, the slice drops below the blade apparatus 30 to an awaiting surface, which may be a container that is removed when filled, or a conveyor belt that carries the slices to another location. Preferably, the awaiting surface is a rotating pizza crust, which may rest upon the pizza pan 60 shown in FIGS. 1-2. A steady stream of pepperoni slices may be created by the slicer 10, and so a pizza crust, preferably with pizza sauce and optionally other toppings, may be rotated and disposed an inch or two beneath the blade apparatus 30 to receive the pepperoni slices until the crust is full or partially full of pepperoni slices.

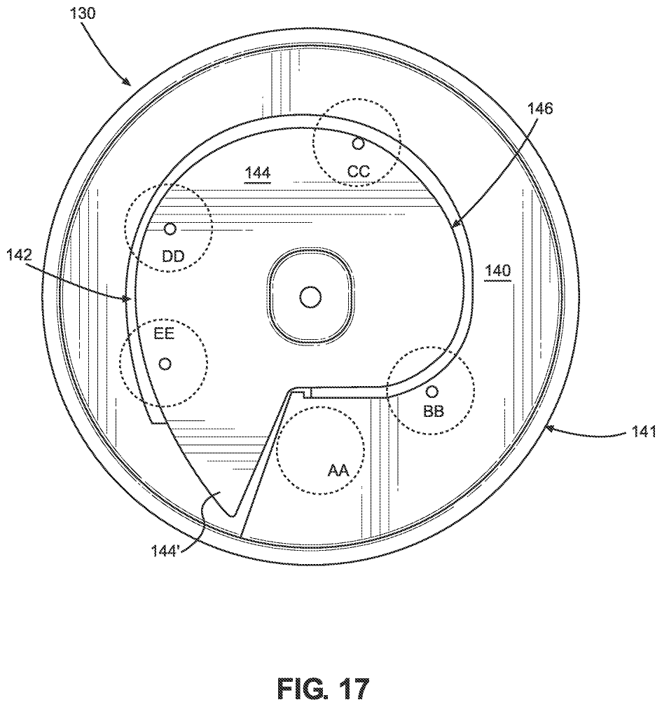

In an alternative embodiment, a second blade is not used as in the embodiment described above. The blade apparatus 130 shown in FIG. 17 includes a guide 140 and a blade 144. The guide 140 may be a substantially planar disk with a substantially circular peripheral edge 141 and a slot 142 formed through the guide 140 radially within the peripheral edge 141. The side or sides of the slot 142 may be chamfered.

The blade 144 may be planar and may be removably mounted to the guide 140, such as by screws, and may have attached, or integral, to it a sharpened peripheral edge 146 that is an involute or a nearly-involute shape. The sharpened edge 146 is preferably able cleanly to slice through food products that have been described herein, and in particular pepperoni food logs. The blade apparatus 130 may otherwise be similar to the blade apparatus 30.

With the blade apparatus 130, as with the blade apparatus 30 operated as described above, the food product begins a cycle in the position AA. As the blade apparatus 130 rotates, the food product moves relative to the blade apparatus 130 to the positions BB, CC, DD and EE, thereby forming a slice that may extend through the slot 142 as the blade 144 rotates. Because there is no second blade in the blade apparatus 130, as the blade 144 rotates beyond the position where the food product is in the position EE, the blade 144 has a sufficient wing portion 144′ that severs the remainder of the food product. Thus, during the rotation of the blade past the position EE, the wing portion 144′ severs the slice from the rest of the food product log. This positions the food log in the position AA, after which another rotational cycle begins.

In one embodiment, shown in FIGS. 1-2 and 11-12, the slicer 10 includes a tray 70 for receiving the pizza pan 60 holding a crust, and the tray 70 may have horizontal arms with stepped surfaces to accommodate different diameter pans on different steps. The tray 70 is mounted to a cart 72 that houses a rotary motor 74 with a vertical driveshaft drivingly linked to the tray 70, thereby causing the tray 70, and the pizza pan 60 placed thereon, to rotate upon actuation of the motor 74.

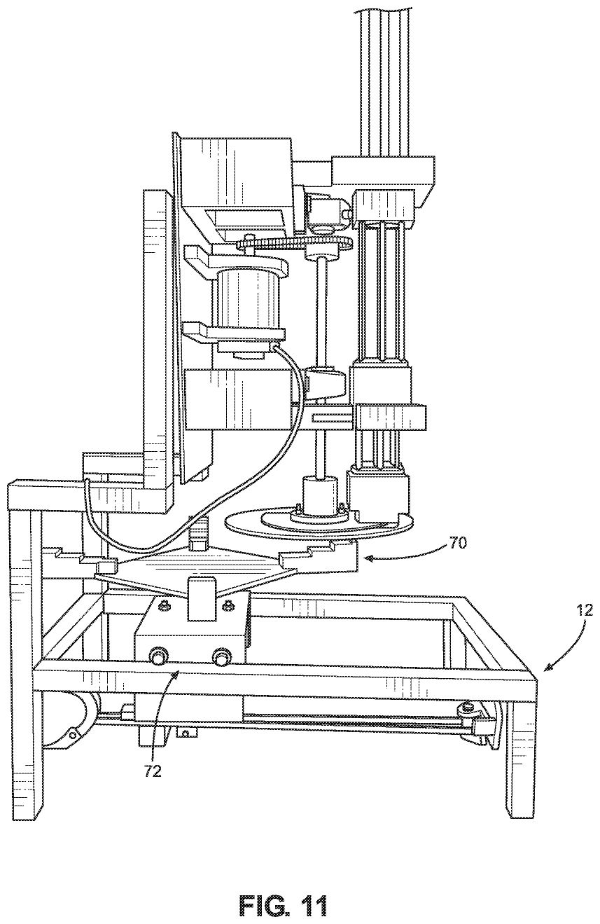

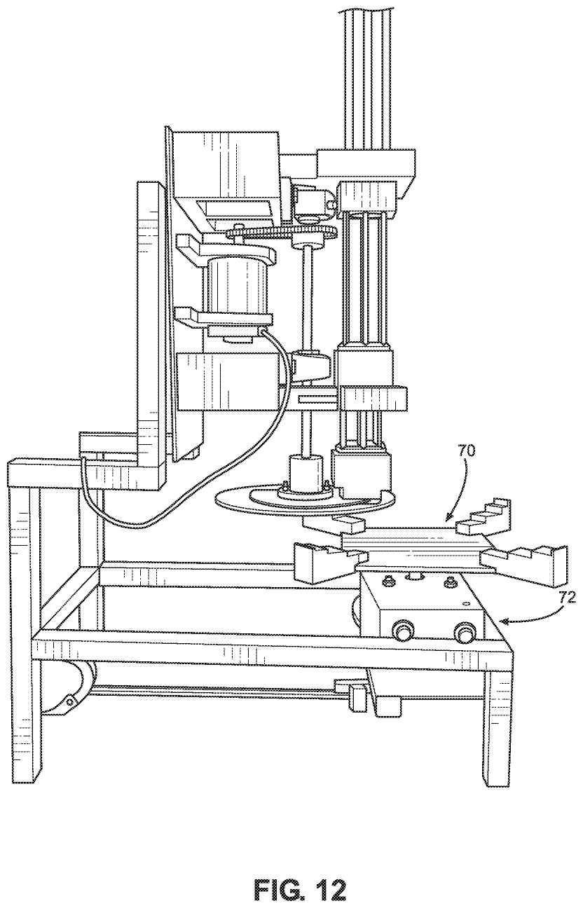

The cart 72 may be configured to move horizontally along the frame 12, such as by wheels 73, or other bearings, resting upon the frame 12. The cart 72 moves horizontally (laterally relative to the axis of rotation of the tray 70) to the left and right in the orientation of the images of FIGS. 11 and 12 (the cart 72 is disposed fully to the left in FIG. 11 and fully to the right in FIG. 12) and smoothly traverses a path that permits the pan to receive slices from the pepperoni stick above through at least the pan's radius. Movement of the cart 72 may be by any means, one of which includes a prime mover, such as a rotary motor 75 that drives a gear (not visible) and a cogged belt 76 attached along one belt span to the cart 72.

As the slicing apparatus 30 drops pepperoni slices near the center of the crust on the rotating pan 60, the cart 72 may displace the rotating pan 60 radially outwardly (horizontally) as the slices are formed, thereby dropping pepperoni slices from the center of the circular rotating crust toward the edge of the crust. Thus, the pattern of slices may be a continuous spiral starting at the center and moving outwardly. The opposite direction is contemplated, so that the slicer 10 may begin dropping slices at the outer edges first and move inwardly. In both cases, as slices are dropped toward the rotating pan 60, the cart 72 continuously moves the crust radially (horizontally) to receive pepperoni slices on portions of the crust where desired. The timing of each slice falling is important, and it is desired that each slice falls in a location as close to adjacent the previous slice as desired to ensure the desired coverage of the pizza crust. The pepperoni slices may be “shingled” on the pizza crust, which means each slice overlaps the previously-placed slice, or they may be spaced a selected distance without touching one another.

Instead of moving the cart 72 continuously, the cart 72 may be moved horizontally a particular distance only at or around the end of each complete rotation of the tray 70. This may be when, rather than forming a spiral, the slices drop into discrete circular rows of ever increasing diameter, such as in the form of concentric circles. Thus, when each circular row of pepperoni slices is completed, and a new row is begun, the cart 72 is moved radially. Then the next pepperoni slice placed on the crust of the pizza pan 60 begins a new circular row. This periodic, rather than continuous, horizontal movement of the cart 72 is referred to as “indexing” from one position to the next. The distance of movement is a distance that is close to the diameter of the sliced food product, meaning slightly more or slightly less than the diameter. The amount of movement depends on whether adjacent slices are desirably overlapping, just contacting or spaced from one another.

In one embodiment, indexing to move the cart 72 horizontally may occur just after the last slice of one circular row is completely separated from the food log. In another embodiment, indexing may occur just after the last slice of one circular row contacts the surface of the pizza crust. In other embodiments, indexing may occur at some other time during the slicing cycle. Nevertheless, when the cart 72 indexes to the next horizontal position, the cart is rapidly moved to the new position so that the first slice in the next circular row of slices falls in the correct position. The cart 72 stays in that horizontal position until that circular row is completed, at which time the cart 72 is indexed to the next horizontal position until the crust is filled with the amount of pepperoni slices desired. Then the process is complete.

The rate of movement of the cart 72 radially/horizontally is essentially constant and relatively slow in the example of the spiral pattern of slice placement. The rate of movement is periodic and rapid in the example of indexing the cart 72. The blade apparatus 30 rotational speed is essentially constant during operation. The angular velocity of pizza crust rotation decreases as the cart 72 moves radially outwardly from the center to ensure the desired coverage by the slices. This angular velocity reduction is because the slices are being produced at the same rate due to consistent blade apparatus 30 rotational speed, and the crust must move at the same speed relative to the slices falling onto the crust in order to space the slices consistently. Modification of the angular velocity of crust rotation ensures the speed of the receiving surface is consistent relative to the rate of slice formation throughout the cutting cycle, thereby resulting in consistent coverage of the receiving surface by the consistent slice formation rate. Of course, these variables may be modified differently by a person of ordinary skill to reach a different combination with the same equipment.

In another embodiment of the slicer, the structure that supports the rotating crust may remain horizontally stationary relative to the frame, and the housing that holds the food product may move horizontally during slicing. That is, in this embodiment, the same lateral/radial/horizontal movement of the rotating pizza crust relative to the food log may be effected by moving horizontally the blade apparatus and the housing that retains the food log and maintain the tray that supports the pizza crust horizontally stationary.

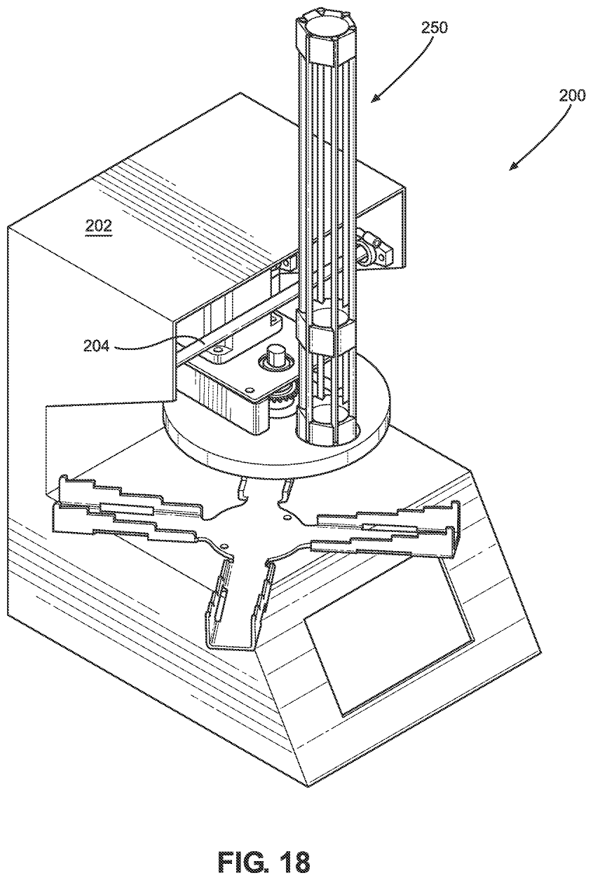

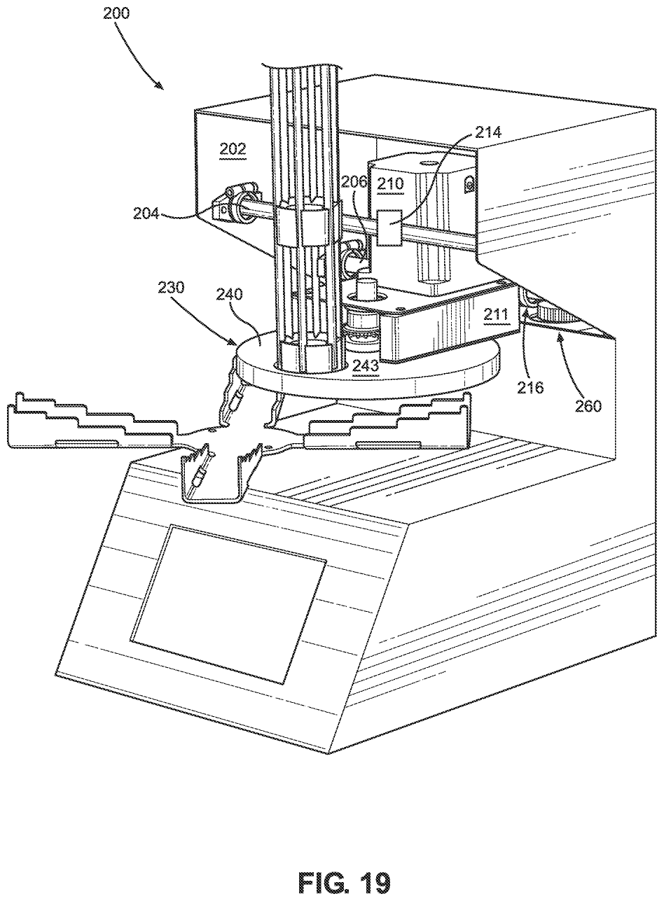

This second embodiment is disclosed in FIGS. 18-19. FIGS. 18 and 19 show a slicer 200 having a frame 202 to which two parallel shafts 204 and 206 are mounted at their ends. The shafts are smooth, preferably horizontal, and bearings 214 and 216 are slidably disposed on the shafts to permit smooth movement along the lengths of the shafts. A motor 210 is mounted to the bearings 214 and 216, the motor may be connected to a central computer that controls all movements of the motor and other components of the slicer 200, and the motor 210 has a vertical driveshaft extending downwardly (in the operable orientation shown in FIG. 18) to a drive mechanism 211 that drives a blade apparatus 230. The blade apparatus 230 is similar to those blade apparatuses described herein: a guide 240 with a top surface 243 on which an elongated food product (not shown) may rest during operation, and a blade (not shown) mounted to the guide 240. The blade has a sharp edge aligned with a slot (not shown) in the guide 240. A housing 250 has a cylindrical, barrel-shaped void into which the elongated food product may be inserted. The housing 250 is mounted to the motor 210 and moves therewith.

When a food product is disposed in the barrel, the motor 210 rotates the blade apparatus 230 and the food product is sliced as described herein. When the need arises for relative horizontal/radial/lateral movement of the food product to a substrate onto which slices fall, the motor 210 is moved along the shafts 204 and 206 by a belt drive 260 or other drive means. The belt drive 260 may have a stepper motor and a cogged belt drivingly linked to the motor 210 to displace the motor 210, and the associated housing 250 for the food product, along the shafts 204 and 206 an incremental amount. This indexing movement may be an amount equal to, or slightly greater than, the diameter of the food product, thereby moving the location where the next slice lands on the substrate by an amount just greater than the diameter of the slice.

A tray 270 is mounted below the motor 210, in the operable orientation shown in FIGS. 18 and 19, and is drivingly linked to at least one tray motor (not visible) that drives the tray 270 rotationally. A substrate, such as a pizza crust pan, may rest on the tray 270 as described herein. The tray motor may have a drive shaft that drivingly links directly to the tray 270, and the shaft may be vertically oriented in an operable configuration.

In some embodiments, the tray 270 may be vertically adjustable, such as parallel to or along the substantially vertical axis of rotation of the tray 270. This permits the crust and pan to be placed on the tray when the tray is positioned several inches or more below the blade apparatus, thereby giving plenty of vertical space to place the crust. Once the crust is placed on the tray, the tray may be raised upwardly to be as close to the lower surface of the blade apparatus as desired, such as one inch. The tray may be moved upwardly by any translating mechanism, including one or more pneumatic or hydraulic rams mounted between the tray and the frame or a stepper motor and drive system.

The preferred rotational speed of the blade is 60-100 rpm, which means 60-100 slices of pepperoni are formed per minute. The speed causes the slices to drop at a predictable location onto the pizza crust directly below the pepperoni stick without creating a substantial radial force that tends to project slices in various directions. Slower cutting speeds also allow the pizza crust that receives the slices to rotate at speeds that will not cause the crust to become unstable or fall off the pan or tray. A rotational speed of the crust is between about 0 and about 500 rpm, and the pizza crust may be rotated in the opposite direction from the rotational direction of the blade apparatus 30.

The slicer 10 may cut pepperoni and drop about 100 pieces of pepperoni on the crust resting on the pan 60. A computer controlling the prime movers and/or motors may be programmed to rotate the tray 70 (or any other tray described herein) at different speeds for different sizes of pizza crusts, and the speed of crust rotation may vary depending on the radial location to which the pepperoni slices may be falling. The range of speeds results in a time to completely apply 60 slices of pepperoni on a pizza crust of about 35 seconds. Once completed, the pan 60 is removed manually and another pan with another crust is placed on the tray 70 to be filled with fresh pepperoni during another cutting cycle.

The use of the second blade 50 in some embodiments results in cleanly cut slices where the casing is severed completely at speeds at which the present invention operates. Because there is a gap between the first blade 44 and the second blade 50, there is the possibility of leaving a small amount of the internal part of the pepperoni intact between the casing and the slice path of the first blade 44. Ordinarily slices fall away from the food log due to the force of gravity even if a small internal portion remains intact. However, if a given slice does not fall away prior to full rotation of the blade 44, a blunt edge 47 (FIG. 4) of the guide 40 defines the end of the slot 42. This blunt edge 47 severs the slice from the food log if the slice has not fallen away by the time the rotating blade apparatus 30 rotates the blunt edge 47 into the small internal portion holding the slice to the food log.

By slicing the food product (e.g., a pepperoni stick) from one side through almost a full revolution of the blade 44, and then optionally slicing the food product using a second blade 50 cutting from the opposite side and in the opposite direction, the probability of forming a “tail” on any slice is reduced.

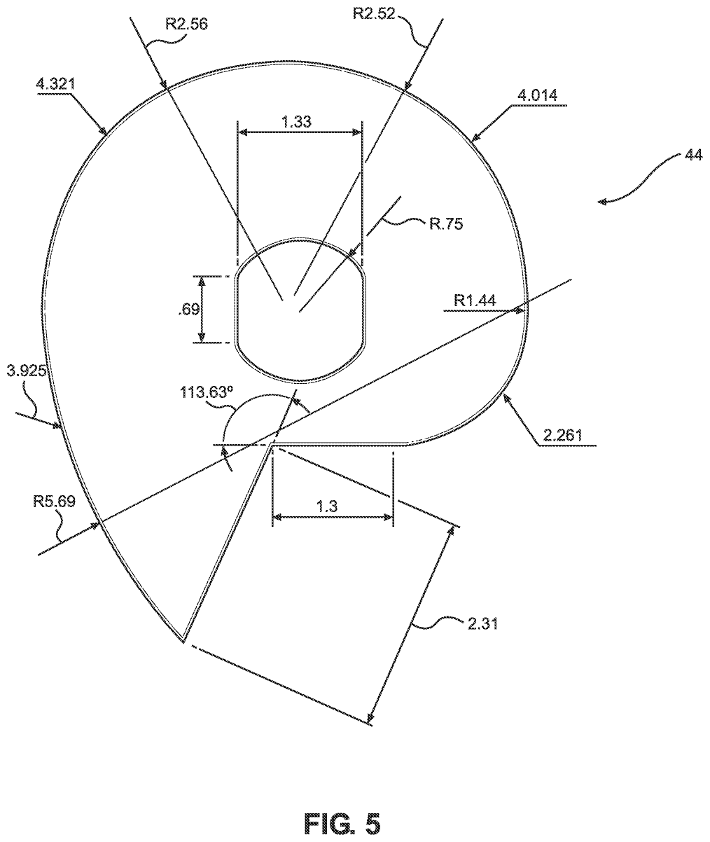

The curvature of the first blade 44, which may have the same curvature as the blade 144, is carefully designed and has various radii of curvature that are shown in FIG. 5. The radius of the blade's curvature changes at different points around the blade 44, and the radial position of the centerpoint of some of the radii change at different points around the blade 44. The first blade 44 starts to cut the food product on the sharp curve marked 2.261 inches radius of curvature. The blade 44 cuts at a faster rate at the beginning of the cut when the portion of the food product supporting the force applied to form the cut is thick and can support the higher force of a rapid cut. The less food material that is holding the pepperoni to the food log, the slower the rate of cut desired. Therefore, the preferred operation is to cut at a faster rate with the first blade 44 during the early portion of the cut, and then slow the rate of cut toward the end of the first blade's 44 cut. As the cut progresses, the blade 44 has an increasing radius of curvature (e.g., 2.52 inches and then 2.56 inches) that cuts more gradually (less quickly) as the blade 44 progresses through the food product and the portion of the food product supporting the slice is smaller. When the blade 44 approaches the end of the cut, the radius of curvature is larger (5.69 inches), and that is about the time the second blade 50, if used, severs the remaining portion of the stick starting from the outside and cutting radially inwardly. By the time the second blade 50 starts its cut, about three-quarters of the thickness of the food product has been cut by the first blade 44.

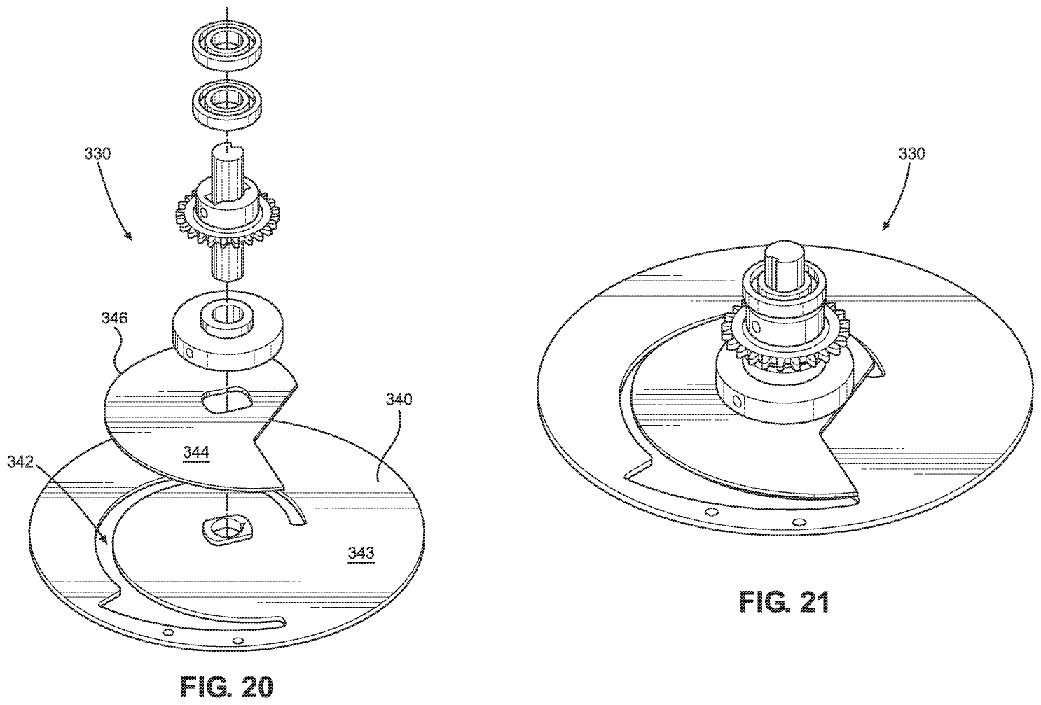

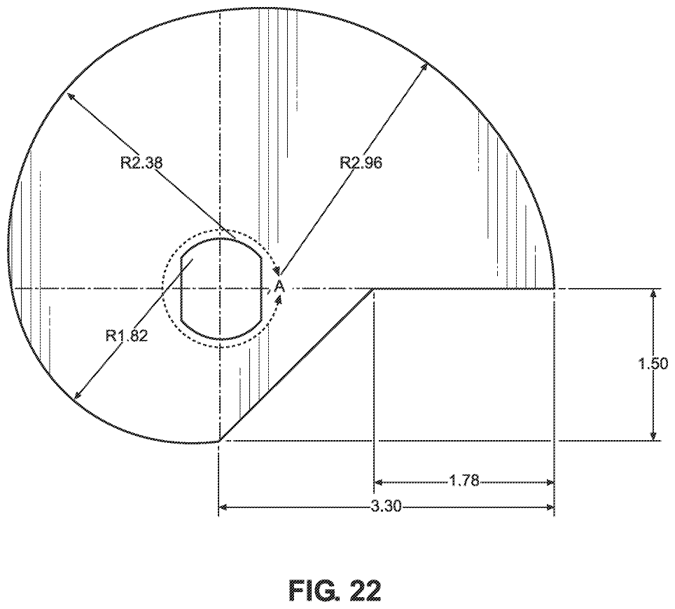

In an alternative blade apparatus 330 shown in FIGS. 20 and 21, the blade apparatus 330 has a blade guide 340 with an upper surface 343 upon which a food product may rest in an operable configuration. A blade 344 is mounted with a sharp edge 346 adjacent a slot 342. The embodiment of FIGS. 20-21 is similar to the embodiment of FIG. 17 inasmuch as they both use only a single blade. The blade 344 of FIGS. 20-21 is shown alone in FIG. 22 with alternative radii and angles compared to other blades disclosed herein.

The height of the barrel 20 may be marked, such as by a divider 22. Thus, when a food log, such as a pepperoni stick, goes below the divider 22 the worker notices this and notes that another food log should desirably be placed on top of the previous food log. This ensures the weight pressing down on the log that is being sliced is sufficient to cut the log as desired. If the weight pressing the log down against the guide 40 is too low, the conditions may not exist to form the desired thickness slices.

In one embodiment, the slicer 10 is a component of a larger apparatus, which may have other functions. For example, the larger apparatus may include apparatuses to add to a pizza crust items such as sauce, cheese and other toppings. The larger apparatus may have a conveyor belt, robotic arms and other structures that convey the pizza pan from one location to the next. The larger apparatus may have means for applying thermal energy to the pizza to cook it or simply heat or cool it to a more desirable temperature.

During operation of the slicers described herein, it is contemplated that the operator may enter data related to the pizza that will desirably be formed by the slicer. Data entered may include crust diameter, slice pattern and slice density, among others. Slices of pepperoni may be arranged on a crust in one of many different configurations. In one configuration, slices may be arranged in a continuous spiral. In another configuration, the slices may be arranged in discrete rows forming concentric circles. Within each of those configurations, the slices may be more closely packed or less closely packed; that is, the edges of each of the slices may contact the edges of adjacent slices placed on the crust in another row, or the slices may be spaced by one millimeter or another of many predefined distances (2 mm, 3 mm, etc.). Thus, the density of pepperoni on a crust may be varied in addition to the configuration of the slices. All of these features may be controlled by a computer, as programmed and based on the data entered by the user prior to operation. Thus, the parameters of operation of the slicer, such as how rapidly the crust is rotated, how rapidly the blade is rotated, how far and when the crust is indexed and possibly other parameters, are controlled by the computer based on programming and data entered.

In one embodiment, a computer controls the speeds of rotation, timing and speed of indexing and other variables, as determined by instructions programmed into the computer, whether in the operating system or applications, or the data entered by an operator of the slicer. The computer then actuates prime movers, such as stepper motors, pneumatic rams, etc. to form the slice pattern programmed. The computer receives the data entered by the user, such as by entering raw information (diameter, speed, etc.) or by selecting predetermined diameters (small, medium large) and densities (closely packed or loosely packed). The operator may enter the data using a touch screen before or after placing the crust on the rotating structure. The operator then starts the slicer, and then the computer controls the all movements of the slicer until completion.

Based on the data entered and the programming, the computer may calculate the speed of rotation of the blade apparatus and the tray. The computer may actuate the rotation at those calculated speeds by controlling the drive motors. The computer may index the food log relative to the rotating crust in order to form the pattern desired. The computer may move the food log relative to the rotating crust in a continuous manner in the case of a spiral configuration pattern. The movement is also controlled by the computer to obtain the density of slice location desired. In one example, the diameter of the crust is entered, as are the number of pepperoni slices desired on the crust and the diameter of the pepperoni slices. Optionally, the density of slice placement may be entered. The computer calculates the area available on the crust for pepperoni, taking into consideration the diameter of the slices, and calculates the speed of the crust movement (indexing or continuous) relative to the blade and pepperoni stick. The computer also calculates the indexing distance, which is the distance the blade and pepperoni stick must be moved horizontally relative to the crust at the end of each crust rotation. All of these movements may be actuated by the computer attached to the prime movers (stepper motors, pneumatic rams, etc.) connected to the computer.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An apparatus for cutting slices from a food product, the apparatus comprising:
(a) a housing defining a barrel configured for receiving an elongated food product;
(b) a rotatable blade apparatus disposed adjacent the housing for cutting slices from the elongated food product during rotation, the rotatable blade apparatus having:
(i) a substantially planar guide with a slot formed therethrough and a top surface disposed a first predetermined distance from the housing; and
(ii) a first blade mounted to the guide and arranged with a sharp edge adjacent the slot, facing radially outwardly and disposed a second, predetermined distance from the housing; and
(c) a substrate disposed adjacent the rotatable blade apparatus for receiving slices formed by the rotatable blade apparatus.

2. The apparatus in accordance with claim 1, further comprising a second blade mounted to the guide adjacent the first blade, wherein a sharp edge of the second blade faces the sharp edge of the first blade.

3. The apparatus in accordance with claim 1, wherein the substrate is rotatable about a substrate axis.

4. The apparatus in accordance with claim 3, wherein the substrate is moveable along the substrate axis to position the substrate closer to the housing during slicing.

5. The apparatus in accordance with claim 3, wherein the substrate is laterally moveable relative to the substrate axis.

6. The apparatus in accordance with claim 5, further comprising:
(a) a displaceable cart disposed, in an operable orientation, beneath the rotatable blade apparatus, the cart having a rotatable tray with an upper surface defining the substrate; and
(b) a prime mover drivingly linked to the cart for displacing the cart laterally relative to an axis of rotation of the rotatable blade apparatus.

7. The apparatus in accordance with claim 1, wherein, in an operable orientation, the housing is substantially vertical, the rotatable blade apparatus is disposed beneath the housing near an end of the barrel and the substrate is disposed beneath the rotatable blade apparatus.

8. The apparatus in accordance with claim 1, wherein the first predetermined distance differs from the second predetermined distance by an amount substantially equal to a thickness of at least one of the slices.

9. The apparatus in accordance with claim 1, wherein the rotatable blade apparatus is laterally moveable relative to the substrate.

10. An apparatus for cutting slices from a food product, the apparatus comprising:
(a) a housing, which in an operable orientation is substantially vertical, defining a barrel configured for receiving an elongated food product;
(b) a rotatable blade apparatus disposed, in an operable orientation, beneath the housing near an end of the barrel, for cutting slices from the elongated food product, the rotatable blade apparatus having:
(i) a substantially planar guide with a slot formed therethrough and a top surface disposed a first predetermined distance from the housing; and
(ii) a first blade mounted to the guide and arranged with a sharp edge adjacent the slot, facing radially outwardly and disposed a second, predetermined distance from the housing, wherein the first predetermined distance and the second predetermined distance differ by a thickness of at least one of the slices; and
(c) a substrate disposed, in an operable orientation, beneath the rotatable blade apparatus for receiving the slices formed.

11. The apparatus in accordance with claim 10, wherein the rotatable blade apparatus further comprises a second blade mounted to the guide adjacent the first blade and with a sharp edge of the second blade facing the sharp edge of the first blade.

12. The apparatus in accordance with claim 10, wherein the substrate is rotatable about a substrate axis.

13. The apparatus in accordance with claim 12, wherein the substrate is moveable along the substrate axis to position the substrate closer to the housing during slicing.

14. The apparatus in accordance with claim 13, wherein the substrate is moveable laterally relative to the substrate axis.

15. The apparatus in accordance with claim 13, wherein the housing and the rotatable blade apparatus are moveable laterally relative to the substrate axis.

16. A method of forming a pizza comprising:
(a) disposing an elongated food product in a barrel formed in a housing, which in an operable orientation is substantially vertical;
(b) disposing a rotatable blade apparatus beneath the housing near an end of the barrel, the rotatable blade apparatus having:
(i) a substantially planar guide with a slot formed therethrough and a top surface disposed a first predetermined distance from the housing; and
(ii) a first blade mounted to the guide and arranged with a sharp edge adjacent the slot, facing radially outwardly and disposed a second, predetermined distance from the housing;
(c) rotating the rotatable blade apparatus with an end of the elongated food product resting on the top surface of the guide and the first blade's sharp edge in contact with the elongated food product, thereby cutting slices from the elongated food product that extend through the slot and fall beneath the guide;
(d) disposing a substrate below the guide for receiving slices.

17. The method in accordance with claim 16, further comprising rotating the substrate about a substrate axis and simultaneously displacing the substrate laterally of the substrate axis.

18. The method in accordance with claim 17, further comprising:
(a) inputting data to a computer that controls a rotational speed of the rotatable blade apparatus and a rotational speed of the substrate; and
(b) the computer controlling the speed of the rotatable blade apparatus and the speed of the substrate as a function of the data input to the computer.
